(19) United States
(12) Patent Application Publication
(10) Pub. No.: US 2010/0162577 A1
(43) Pub. Date: Jul. 1, 2010

(54) Fruit Slicer having Replaceable Cutters

(76) Inventor: Hsing-Hui Chen, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/346,289

(22) Filed: Dec. 30, 2008

(51) Int. Cl. B26B 3/04

(52) U.S. Cl. 30/302

(57) ABSTRACT

A fruit slicer includes a support base, a movable base movable relative to the support base, and at least two cutters each selectively mounted on the movable base to move in concert with the movable base and each movable to abut and press the support base. Thus, each of the cutters is detachably mounted on the movable base so that the movable base can co-operate with the cutters of different types and kinds to slice fruits with or without cores.

### BACKGROUND OF THE INVENTION

1. Field of the Invention

The present invention relates to a slicer and, more particularly, to a fruit slicer to divide a fruit, such as an apple, orange and the like, into multiple parts.

2. Description of the Related Art

A conventional fruit slicer in accordance with the prior art shown in FIG. 5 comprises a circular press seat 110 having a periphery provided with two opposite protruding press handles 111, a tubular blade 121 located at the central portion of the circular press seat 110, and a plurality of flat blades 120 connected between the circular press seat 110 and the tubular blade 121. Thus, the flat blades 120 co-operates with the tubular blade 121 to cut a fruit with a core, such as an apple, so as to slice and divide the fruit into multiple parts. However, the fruit slicer can be used to cut a fruit with a core, such as an apple, and cannot be used to cut a fruit without a core, such as an orange, thereby limiting the versatility of the fruit slicer. In addition, when the forces applied on the two press handles 111 by a user's hands are not distributed evenly, the fruit slicer cannot cut the fruit smoothly and stably, thereby decreasing the cutting efficiency of the fruit slicer. Further, the sliced fruit chips or juice are easily spilled outwardly from the circular press seat 110 during the cutting process, thereby causing inconvenience to the user when managing the sliced fruit chips or juice.

### BRIEF SUMMARY OF THE INVENTION

In accordance with the present invention, there is provided a fruit slicer, comprising a support base, a movable base movable relative to the support base, and at least two cutters each selectively and detachably mounted on the movable base to move in concert with the movable base and each movable to abut and press the support base.

The primary objective of the present invention is to provide a fruit slicer having replaceable cutters.

Another objective of the present invention is to provide a fruit slicer, wherein each of the cutters is selectively and detachably mounted on the movable base so that the movable base can co-operate with the cutters of different types and kinds to slice fruits with or without cores, thereby enhancing the versatility of the fruit slicer.

A further objective of the present invention is to provide a fruit slicer, wherein the guide plates can guide movement of the movable base relative to the support base so that the movable base is movable relative to the support base smoothly and stably without incurring deflection or upset so as to facilitate the user operating the press handles of the movable base and to enhance the cutting efficiency of the cutters.

A further objective of the present invention is to provide a fruit slicer, wherein the protective barrel abuts the top of the movable base to move with the movable base to prevent the sliced fruit chips or juice from being sputtered or spilled outwardly from the movable base during the cutting process.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a fruit slicer in accordance with the preferred embodiment of the present invention.

FIG. 2 is an exploded perspective view of the fruit slicer as shown in FIG. 1.

FIG. 3 is a partially front cross-sectional view of the fruit slicer as shown in FIG. 1.

FIG. 4 is a locally enlarged view of the fruit slicer taken along circle “A” as shown in FIG. 3.

FIG. 5 is a perspective view of a conventional fruit slicer in accordance with the prior art.

### DETAILED DESCRIPTION OF THE INVENTION

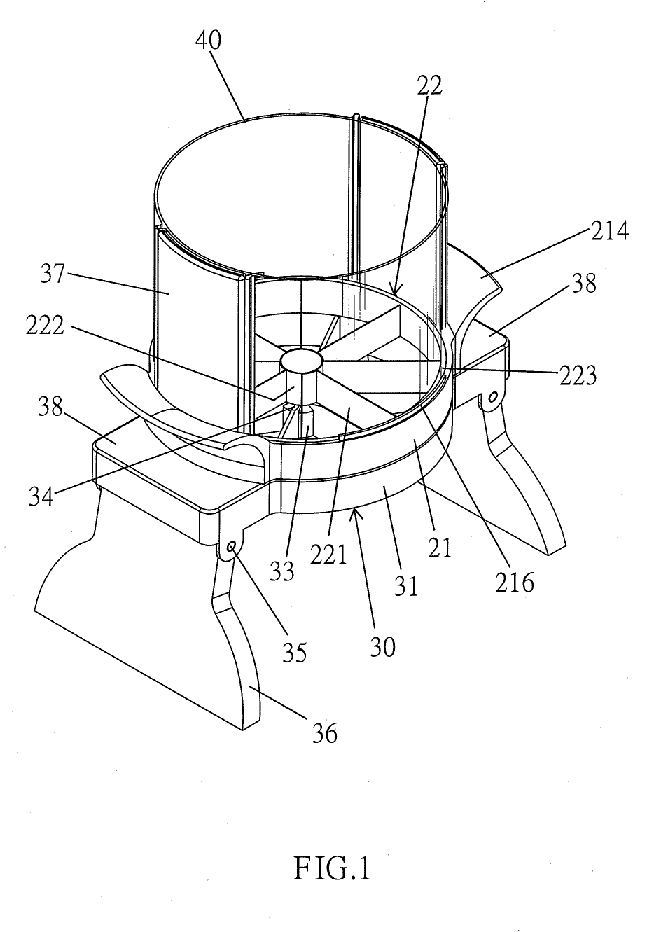

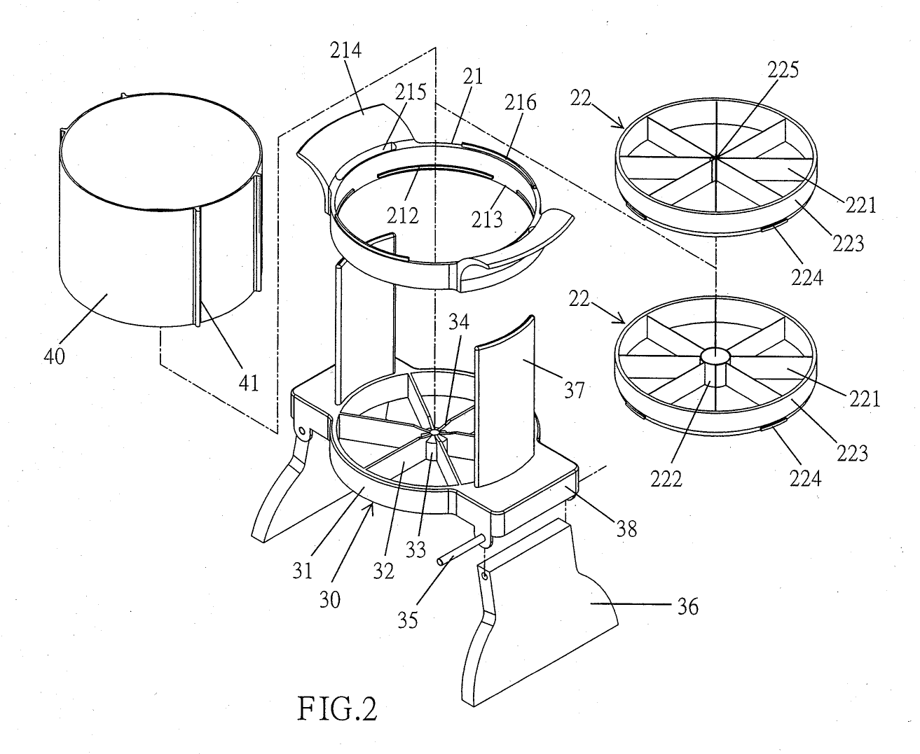

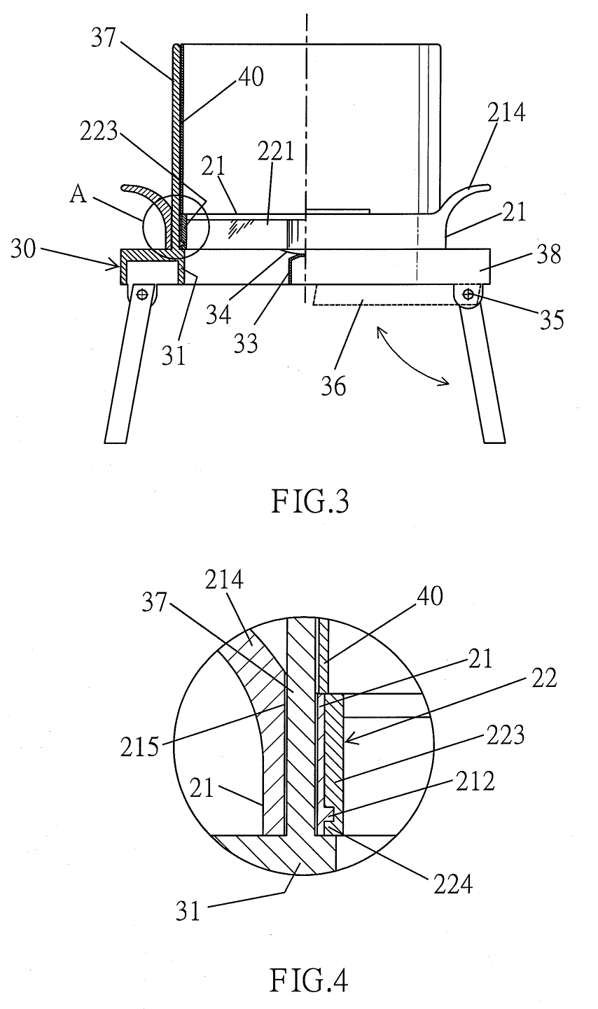

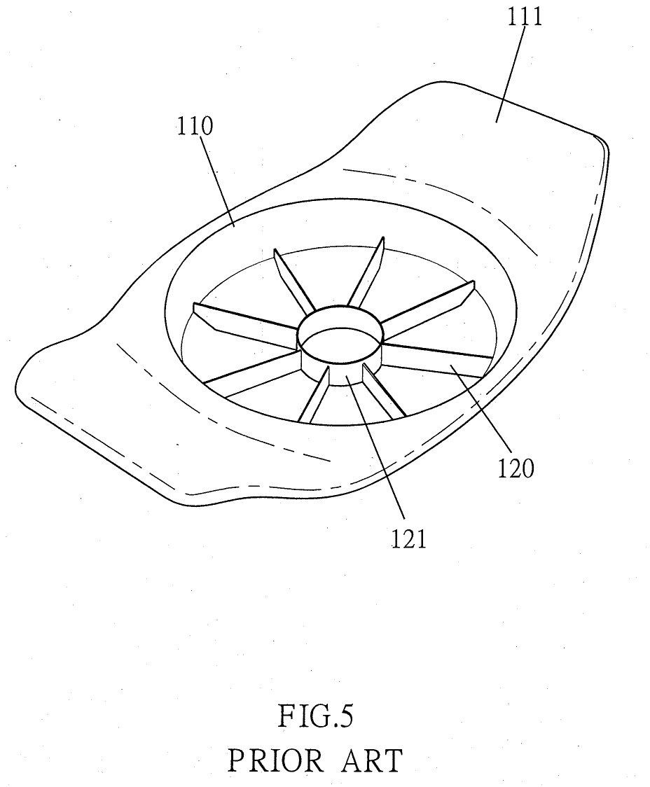

Referring to FIGS. 1-4, a fruit slicer in accordance with the preferred embodiment of the present invention comprises a support base 30, a movable base 21 movable relative to the support base 30, at least two cutters 22 each selectively and detachably mounted on the movable base 21 to move in concert with the movable base 21 and each movable to abut and press the support base 30, two opposite stands 36 mounted on a bottom of the support base 30 to lift and support the support base 30, two upright guide plates 37 each mounted on a top of the support base 30 and each extending through the movable base 21 to guide movement of the movable base 21 relative to the support base 30, and a protective barrel 40 abutting a top of the movable base 21 to move in concert with the movable base 21.

The support base 30 includes an annular seat 31, a recessed receiving portion 34 located at a central portion of the annular seat 31, and a plurality of support ribs 32 mounted between the annular seat 31 and the receiving portion 34.

The annular seat 31 of the support base 30 has a peripheral wall provided with two opposite protruding blocks 38 for mounting the two guide plates 37 and the two stands 36. The central portion of the annular seat 31 of the support base 30 is provided with a reinforcing stud 33 located under the receiving portion 34 and connected between the support ribs 32. The support ribs 32 of the support base 30 are arranged in a radiating manner in the annular seat 31. The receiving portion 34 of the support base 30 is used to receive a fruit, such as an apple, orange and the like. Each of the two guide plates 37 has a substantially arc-shaped profile. Each of the two stands 36 is pivotally and foldably mounted on the support base 30 by a shaft 35.

The movable base 21 is movable to abut and press the annular seat 31 of the support base 30. The movable base 21 is movably mounted between the two guide plates 37 and is provided with two opposite protruding press handles 214 each located outside of and aligning with a respective one of the two guide plates 37. The movable base 21 has a peripheral wall provided with two opposite guide slots 215 each movably mounted on a respective one of the two guide plates 37 and each aligning with a respective one of the two press handles 214. Each of the two guide slots 215 of the movable base 21 has a substantially arc-shaped profile. The movable base 21 has a substantially annular shape and has an inner wall provided with a plurality of stop flanges 212 and a plurality of passages 213 defined between the stop flanges 212. The top of the movable base 21 is provided with a plurality of limit pieces 216 each inserted into an inner wall of the protective barrel 40 to limit the protective barrel 40 onto the movable base 21.

Each of the cutters 22 includes a mounting ring 223 detachably mounted in the movable base 21 and a plurality of flat blades 221 mounted in the mounting ring 223 to move in concert with the movable base 21.

The mounting ring 223 of each of the cutters 22 is movable to abut and press the annular seat 31 of the support base 30. The mounting ring 223 of each of the cutters 22 abuts the stop flanges 212 of the movable base 21 and has an outer wall provided with a plurality of locking lugs 224 each extending through a respective one of the passages 213 of the movable base 21 and each locked onto a respective one of the stop flanges 212 of the movable base 21 to detachably lock the mounting ring 223 of each of the cutters 22 in the movable base 21.

In assembly, each of the locking lugs 224 of each of the cutters 22 is moved downward to extend through the respective passage 213 of the movable base 21. Then, each of the cutters 22 is rotated relative to the movable base 21 so that each of the locking lugs 224 of each of the cutters 22 is moved to abut the respective stop flange 212 of the movable base 21 to detachably lock the mounting ring 223 of each of the cutters 22 in the movable base 21.

Each of the flat blades 221 of each of the cutters 22 is movable to abut and press a respective one of the support ribs 32 of the support base 30. The flat blades 221 of each of the cutters 22 are arranged in a radiating manner in the mounting ring 223. The flat blades 221 of one of the cutters 22 intersect each other at a connection 225 which is located at the central portion of the mounting ring 223 so that the flat blades 221 co-operates with the connection 225 to cut a fruit without a core, such as an orange. Another one of the cutters 22 further includes a tubular blade 222 located at the central portion of the mounting ring 223, and the flat blades 221 are located between the mounting ring 223 and the tubular blade 222 so that the flat blades 221 co-operates with the tubular blade 222 to cut a fruit with a core, such as an apple. The tubular blade 222 is movable to abut and press the receiving portion 34 of the support base 30.

The protective barrel 40 is movably mounted between the two guide plates 37 and is located between the two press handles 214 of the movable base 21. The protective barrel 40 has an outer wall provided with two opposite guide tracks 41 each movably mounted on a respective one of the two guide plates 37 to guide movement of the protective barrel 40 relative to the two guide plates 37.

In operation, when a fruit is placed on the receiving portion 34 of the support base 30, a user can apply a downward force on the two press handles 214 of the movable base 21 to move the movable base 21 toward the annular seat 31 of the support base 30, so that any one of the cutters 22 is moved toward the annular seat 31 of the support base 30 to clamp the fruit between any one of the cutters 22 and the annular seat 31 of the support base 30. In such a manner, the flat blades 221 of any one of the cutters 22 are moved to extend through the fruit and to abut and press the support ribs 32 of the support base 30 so as to slice and divide the fruit into multiple parts. At this time, a dish (not shown) is located under the annular seat 31 of the support base 30 to receive the sliced fruit chips and juice. Thus, the guide plates 37 can guide movement of the movable base 21 relative to the support base 30 so that the movable base 21 is movable relative to the support base 30 smoothly and stably without incurring deflection or upset so as to facilitate the user operating the press handles 214 of the movable base 21 and to enhance the cutting efficiency of the cutters 22. In addition, the protective barrel 40 abuts the top of the movable base 21 to move with the movable base 21 to prevent the sliced fruit chips or juice from being sputtered or spilled outwardly from the movable base 21 during the cutting process and to facilitate the user managing the sliced fruit chips and juice.

Accordingly, each of the cutters 22 is selectively and detachably mounted on the movable base 21 so that the movable base 21 can co-operate with the cutters 22 of different types and kinds to slice fruits with or without cores, thereby enhancing the versatility of the fruit slicer. In addition, the guide plates 37 can guide movement of the movable base 21 relative to the support base 30 so that the movable base 21 is movable relative to the support base 30 smoothly and stably without incurring deflection or upset so as to facilitate the user operating the press handles 214 of the movable base 21 and to enhance the cutting efficiency of the cutters 22. Further, the protective barrel 40 abuts the top of the movable base 21 to move with the movable base 21 to prevent the sliced fruit chips or juice from being sputtered or spilled outwardly from the movable base 21 during the cutting process.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fruit slicer, comprising:
a support base;
a movable base movable relative to the support base;
at least two cutters each selectively and detachably mounted on the movable base to move in concert with the movable base and each movable to abut and press the support base.

2. The fruit slicer of claim 1, wherein each of the cutters includes:
a mounting ring detachably mounted in the movable base;
a plurality of flat blades mounted in the mounting ring to move in concert with the movable base.

3. The fruit slicer of claim 2, wherein the support base includes:
an annular seat;
a recessed receiving portion located at a central portion of the annular seat;
a plurality of support ribs mounted between the annular seat and the receiving portion.

4. The fruit slicer of claim 3, wherein
the mounting ring of each of the cutters is movable to abut and press the annular seat of the support base;
each of the flat blades of each of the cutters is movable to abut and press a respective one of the support ribs of the support base.

5. The fruit slicer of claim 3, further comprising:
two upright guide plates each mounted on a top of the support base and each extending through the movable base to guide movement of the movable base relative to the support base.

6. The fruit slicer of claim 5, further comprising:
two opposite stands mounted on a bottom of the support base to lift and support the support base.

7. The fruit slicer of claim 5, further comprising:
a protective barrel abutting a top of the movable base to move in concert with the movable base.

8. The fruit slicer of claim 7, wherein the protective barrel is movably mounted between the two guide plates.

9. The fruit slicer of claim 8, wherein the protective barrel has an outer wall provided with two opposite guide tracks each movably mounted on a respective one of the two guide plates to guide movement of the protective barrel relative to the two guide plates.

10. The fruit slicer of claim 3, wherein the central portion of the annular seat of the support base is provided with a reinforcing stud located under the receiving portion and connected between the support ribs.

11. The fruit slicer of claim 3, wherein
the support ribs of the support base are arranged in a radiating manner in the annular seat;
the flat blades of each of the cutters are arranged in a radiating manner in the mounting ring.

12. The fruit slicer of claim 5, wherein the movable base is provided with two opposite protruding press handles each located outside of and aligning with a respective one of the two guide plates.

13. The fruit slicer of claim 12, wherein the movable base has a peripheral wall provided with two opposite guide slots each movably mounted on a respective one of the two guide plates and each aligning with a respective one of the two press handles.

14. The fruit slicer of claim 13, wherein
the movable base has a substantially annular shape.
each of the two guide plates has a substantially arc-shaped profile;
each of the two guide slots of the movable base has a substantially arc-shaped profile.

15. The fruit slicer of claim 2, wherein
the movable base has an inner wall provided with a plurality of stop flanges and a plurality of passages defined between the stop flanges;
the mounting ring of each of the cutters abuts the stop flanges of the movable base;
the mounting ring of each of the cutters has an outer wall provided with a plurality of locking lugs each extending through a respective one of the passages of the movable base and each locked onto a respective one of the stop flanges of the movable base to detachably lock the mounting ring of each of the cutters in the movable base.

16. The fruit slicer of claim 7, wherein the top of the movable base is provided with a plurality of limit pieces each inserted into an inner wall of the protective barrel to limit the protective barrel onto the movable base.

17. The fruit slicer of claim 11, wherein the flat blades of one of the cutters intersect each other at a connection which is located at a central portion of the mounting ring.

18. The fruit slicer of claim 11, wherein
one of the cutters further includes a tubular blade located at a central portion of the mounting ring;
the flat blades are located between the mounting ring and the tubular blade.
the tubular blade is movable to abut and press the receiving portion of the support base.

19. The fruit slicer of claim 6, wherein
the annular seat of the support base has a peripheral wall provided with two opposite protruding blocks for mounting the two guide plates and the two stands;
each of the two stands is pivotally and foldably mounted on the support base by a shaft.

20. The fruit slicer of claim 5, wherein
the movable base is movably mounted between the two guide plates;
the movable base is movable to abut and press the annular seat of the support base.
